(19) United States
(12) Patent Application Publication
(10) Pub. No.: US 2020/0189894 A1
(43) Pub. Date: Jun. 18, 2020

(54) MULTI-PURPOSE BOTTLE OPENER

(71) Applicants: Costel Caraciobanu, Penticton (CA); Vasile Butcura, Burnaby (CA)

(72) Inventors: Costel Caraciobanu, Penticton (CA); Vasile Butcura, Burnaby (CA)

(21) Appl. No.: 16/221,648

(22) Filed: Dec. 17, 2018

(51) Int. Cl. B67B 7/44; B67B 7/16; B67B 7/04

(52) U.S. Cl. CPC B67B 7/44; B67B 7/0411; B67B 7/16

(57) ABSTRACT

A multi-purpose bottle opener is disclosed. The multi-purpose bottle opener having a bottle opening body having a bottle cap opening end and a wine bottle opening end. The bottle cap opening end having a fulcrum arm and a handle access opening. The fulcrum arm having a cap relief and a cap hook configured to provide leverage against a pry-off-type bottle cap edge, so as to enhance the effectiveness of removal of the bottle cap. The wine bottle opening end being opposite of the bottle cap opening end. The wine bottle opening end having a fixedly mounted corkscrew. A detachable bottle opening handle having a cavity is attachable to the wine bottle opening end such that the fixedly mounted corkscrew is insertable within the cavity. The detachable bottle opening handle configured to be insertable into the handle access opening.

### REFERENCE TO PENDING APPLICATIONS

This application does not claim the benefit of any issued U.S. patent or pending application.

### BACKGROUND OF THE INVENTION

### Field of the Invention

The present invention generally relates to a bottle opener, and in particular to a multi-purpose bottle opener having the capability to open wine bottle and bottle cap bottles.

### Background

A corkscrew is a kitchen tool for drawing corks from wine bottles. Generally, a corkscrew consists of a pointed metallic helix (often called the “worm”) attached to a handle. The user grips the handle and screws the metal point into the cork, until the helix is firmly embedded, then a vertical pull on the corkscrew extracts the cork from the bottle. Corkscrews are necessary because corks themselves, being small and smooth, are difficult to grip and remove, particularly when inserted fully into an inflexible glass bottle. The handle of the corkscrew, often a horizontal bar of wood attached to the screw, allows for a commanding grip to ease removal of the cork. Corkscrew handles may incorporate levers that further increase the amount of force that can be applied outwards upon the cork.

Various forms of wine bottle openers, such as cork screws, exist. For instance, the common wine opener, also known as a sommelier knife, waiter's friend, or wine key, consists of a flat housing, often plastic covered, similar to a Swiss army knife with a corkscrew and lever, which may double as a crown cork opener.

Various forms of bottle cap openers for opening common beer bottle functions in a different way from the standard corkscrew-based wine bottle openers. When there is a need to open a beer bottle or a wine bottle, there is a need to have appropriate opener for the particular type of bottle. This requests the need to have two or more different bottle openers. What is needed in the art is a multi-purpose bottle opener having the capability to open both wine bottles and bottle cap bottles.

### SUMMARY OF THE INVENTION

The present invention generally relates to a bottle opener, and in particular to a multi-purpose bottle opener having the capability to open wine bottle and bottle cap bottles.

In one aspect, a multi-purpose bottle opener is disclosed. The opener may include a bottle opening body having a bottle cap opening end and a wine bottle opening end. The bottle cap opening end having a fulcrum arm and a handle access opening. The fulcrum arm having a cap relief and a cap hook configured to provide leverage against a pry-off-type bottle cap edge, so as to enhance the effectiveness of removal of the bottle cap. The wine bottle opening end being opposite of the bottle cap opening end. The wine bottle opening end having a fixedly mounted corkscrew. A detachable bottle opening handle may also be included. The handle may have a cavity. The detachable bottle opening handle attachable to the wine bottle opening end such that the fixedly mounted corkscrew is insertable within the cavity. The detachable bottle opening handle configured to be insertable into the handle access opening.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective side view of an embodiment of the present invention.

FIG. 2 is an additional perspective side view of an embodiment of the present invention.

FIG. 3 is a cross-sectional view of an embodiment of the present invention.

FIG. 4 is a perspective view of an embodiment of the present invention in a corkscrew configuration.

### DETAILED DESCRIPTION OF THE INVENTION

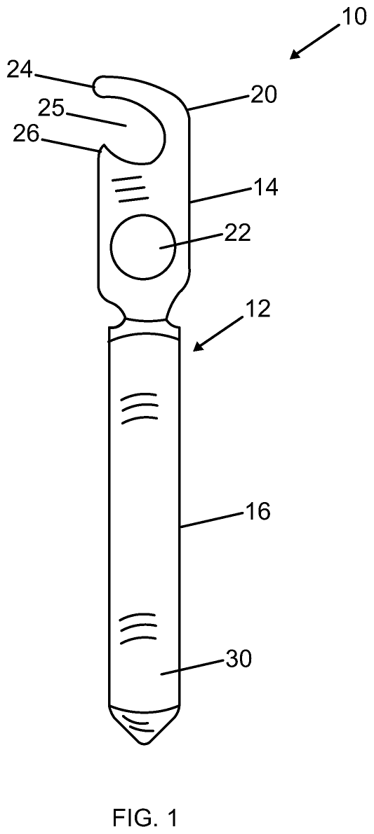

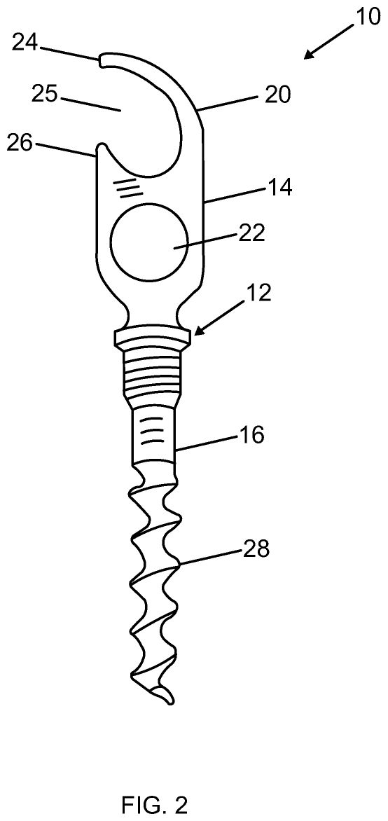

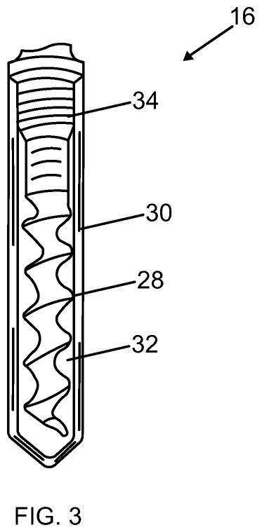

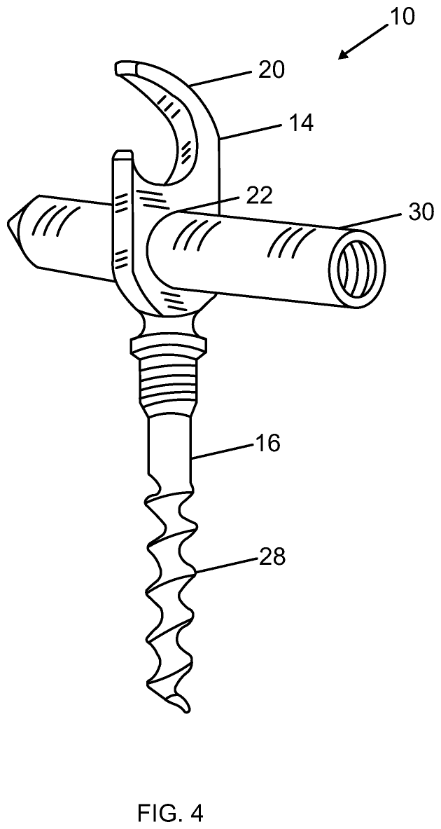

As illustrated in FIGS. 1 to 4, an embodiment of a multi-purpose bottle opener 10 is disclosed. Opener 10 may include a bottle opening body 12 having a bottle cap opening end 14 and a wine bottle opening end 16.

The bottle cap opening end 14 may have a fulcrum arm 20 and a handle access opening 22. The fulcrum arm 20 has a cap relief 24 and a cap hook 26 creating a notch 25. The fulcrum arm 20 is configured to provide leverage against a pry-off-type bottle cap edge. so as to enhance the effectiveness of removal of the bottle cap.

The wine bottle opening end 16 is opposite from the bottle cap opening end 14. Wine bottle opening end 16 having a fixedly mounted corkscrew 28. The corkscrew 28 is designed for penetration into a cork for removal from a wine bottle.

A detachable bottle opening handle 30 is attachable to the wine bottle opening end 16. In some embodiments, handle 30 is detactably secured to wine bottle opening end 16 by a threaded securing fastener 34.

In some embodiments, handle 30 has a cavity 32 such that the fixedly mounted corkscrew 28 is insertable within cavity 32 when handle 30 is secured to wine bottle opening end 16.

Handle 30 is configured to be insertable through handle access opening 22 to provide rotational capability for the engagement of a cork by corkscrew 28 and its removal from of within a wine bottle.

In operation to remove a beer bottle cap, the cap is inserted into the notch 25 with the cap hook 26 being disposed slightly underneath the cap to clamp it. The user can easily remove the cap providing leverage against the cap.

In operation to remove a wine bottle cork, the handle 30 is removed from the wine bottle opening end 16 and inserted through the handle access opening 22 to allow for the rotation of the corkscrew 28 into a cork and for the removal of the cork following the engagement of the cork by the corkscrew 28.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A multi-purpose bottle opener comprising:
a bottle opening body having a bottle cap opening end and a wine bottle opening end; the bottle cap opening end having a fulcrum arm and a handle access opening,
the fulcrum arm having a cap relief and a cap hook configured to provide leverage against a pry-off-type bottle cap edge, so as to enhance the effectiveness of removal of the bottle cap,
the wine bottle opening end being opposite of the bottle cap opening end, the wine bottle opening end having a fixedly mounted corkscrew; and
a detachable bottle opening handle having a cavity, the detachable bottle opening handle attachable to the wine bottle opening end such that the fixedly mounted corkscrew is insertable within the cavity, the detachable bottle opening handle configured to be insertable into the handle access opening.
